(19) United States
(12) Patent Application Publication
(10) Pub. No.: US 2016/0323835 A1
(43) Pub. Date: Nov. 3, 2016

(54) Method for Power Processing and Terminal

(71) Applicant: ZTE CORPORATION, Shenzhen, Guangdong (CN)

(72) Inventors: Zhongming CHEN, Shenzhen (CN); Zhongda DU, Shenzhen (CN)

(21) Appl. No.: 15/107,464

(22) PCT Filed: May 26, 2014
(86) PCT No.: PCT/CN2014/078403

§ 371 Date: Jun. 23, 2016

(30) Foreign Application Priority Data
Dec. 26, 2013 (CN) 201310732840.2

(51) Int. Cl. H04W 52/36; H04W 52/40; H04W 52/14

(52) U.S. Cl. CPC H04W 52/367; H04W 52/146; H04W 52/40

(57) ABSTRACT

A method for power processing and a terminal are disclosed, the method includes: after receiving a command for power adjustment, a terminal performing power adjustment; when detecting that transmission power exceeds a threshold value, or within a specified time period, a time that the transmission power exceeds the threshold value reaches a specified value or a lasting time that the transmission power exceeds the threshold value reaches a specified value, or detecting that a number of times for receiving the specified command for power adjustment in a specified time period exceeds a specified number of times, the terminal reporting the detection information to a base station. With the embodiments of the present document, the probability that the current transmission power of the terminal exceeds a maximum transmission power can be reduced, or the number of times of the power adjustment for the terminal can be reduced.

### TECHNICAL FIELD

The present document relates to the communication field, and specifically, to a method for power processing and a terminal.

### BACKGROUND OF THE RELATED ART

In the LTE system, the current transmission power of a user equipment (UE) cannot exceed maximum transmission power of the UE, generally speaking, the UE informs the difference between the maximum transmission power of the UE and the transmission power of the current Uplink Shared Channel (UL-SCH for short) to an eNB (a base station) through a PHR (Power Headroom Report) procedure, the base station performs the uplink scheduling and link adaptation according to the difference, and further decides whether to perform the power control (for example, reduce the transmission power or increase the transmission power, and the amount of power that need to be adjusted) to satisfy the requirement which is that the current transmission power of the UE cannot exceed the maximum transmission power of the UE. The PHR procedure is achieved by UE sending Media Access Control Control Element (MAC CE for short) of the PHR to the network side, as shown in FIG. 1.

After the Carrier Aggregation (CA for short) is introduced, the UE can communicate with the source base station through a plurality of component carriers (for example, CC1, CC2) at the same time after entering a connection status, and the Primary Cell (Pcell for short) and Secondary Cell (Scell for short) are introduced. Due to the promotion of the data volume, the number of the Scell will increase, for example, it can increase to 4, and the scenario also will be wider, for example, the uplink Remote Radio Head (RRH) and the repeater are supported. Since a plurality of serving cells are in the same base station, the protocol architecture of the user plane has not changed, the reporting manner of the PHR is only aim at introducing a plurality of serving cells, so reporting the PHR of all the activated cell at the same time is needed, and as the Pcell can send the Physical Uplink Control Channel (PUCCH) and the Physical Uplink Shared Channel (PUSCH) at the same time, a reporting type is added, when sending the PUCCH and the PUSCH at the same time, the reported type is named as type 2, and the original reporting type is named as type 1, and the others has not changed.

Due to the lack of the spectrum resource and the sharp increase of the high-traffic services of the mobile users, the demand of using high-frequency points such as 3.5 GHz to cover the hot points is increasingly obvious, and using low power nodes becomes a new application scenario, which is used to increase the user throughput and enhance the mobile performance. But because of the signal attenuation of high-frequency points is relatively serious, the coverage of the cells is relatively small, and the cells do not shared a site with relative cells, at present a lot of companies and operators all tend to seek a new enhancement scheme, Dual Connectivity is one of them. Under the condition of Dual Connectivity, a terminal can keep connections with two or more network nodes at the same time, but the control plane connection only has a connection with one of these cells (such as macro cell). The difference with the carrier aggregation is that the multiple service nodes of the terminal are multiple base stations and the time delay between the base stations cannot be ignored. For example, one network node is a macro base station which is called MeNB, and another network node is a small cell base station which is called SeNB. Under the background of Dual Connectivity, there is no disclosed technique on PHR reporting and power control process by far.

### SUMMARY

The technical problem required to be solved in the present document is to provide a method for power processing and a terminal to reduce the probability that the current transmission power of a terminal exceeds the maximum transmission power, or reduce the number of times of power adjustment for the terminal.

In order to solve the above technical problem, the present document provides a method for power processing, comprising:

After receiving a command for power adjustment, a terminal performing power adjustment;

when detecting that transmission power exceeds a threshold value, or within a specified time period, a time that the transmission power exceeds the threshold value reaches a specified value or a lasting time that the transmission power exceeds the threshold value reaches a specified value, or detecting that a number of times for receiving a specified command for power adjustment in a specified time period exceeds a specified number of times, the terminal reporting detection information to a base station.

Alternatively, the above method further has the following characteristic:

the threshold value comprises maximum transmission power of the terminal.

Alternatively, the above method further has the following characteristic: the number of times for receiving a specified command for power adjustment comprises a number of times for receiving the following commands:

a command for power increase, or

a command for power reduction, or

a command for power increase and a command for power reduction.

Alternatively, the above method further has the following characteristic: the reporting detection information to a base station comprises:

reporting the detection information to a macro base station; or

reporting the detection information to a small cell base station; or

reporting the detection information to a macro base station and a small cell base station.

In order to solve the above problem, the present document further provides a terminal, comprising:

an adjusting module, configured to, after receiving a command for power adjustment, perform power adjustment;

a processing module, configured to, when detecting that transmission power exceeds a threshold value, or within a specified time period, a time that the transmission power exceeds the threshold value reaches a specified value or a lasting time that the transmission power exceeds the threshold value reaches a specified value, or detecting that a number of times for receiving a specified command for power adjustment in a specified time period exceeds a specified number of times, report detection information to a base station.

Alternatively, the above terminal further has the following characteristic:

the threshold value which is exceeded by the transmission power detected by the processing module, comprises maximum transmission power of the terminal.

Alternatively, the above terminal further has the following characteristic:

the number of times for receiving a specified command for power adjustment received which is detected by the processing module comprises a number of times for receiving the following commands: a command for power increase, or a command for power reduction, or a command for power increase and a command for power reduction.

Alternatively, the above terminal further has the following characteristic:

the processing module being configured to report detection information to the base station comprises: reporting the detection information to a macro base station; reporting the detection information to a small cell base station; or reporting the detection information to a macro base station and a small cell base station.

In conclusion, the embodiment of the present document provides a method for power processing and a terminal, which can reduce the probability that the current transmission power of the terminal exceeds a maximum transmission power, or reduce the number of times of the power adjustment for the terminal.

### BRIEF DESCRIPTION OF DRAWINGS

The accompanying drawings illustrated herein is to provide a further understanding to the present document, which constitutes a part of the present application, the schematic embodiments and the illustrations of the present document are used to explain the present document, and do not constitute an inappropriate limitation to the present document. In the accompanying drawings:

FIG. 1 is a flow chart of reporting PHR of the related art;

FIG. 2 is a flow chart of a method for power processing according to the embodiment of the present document;

FIG. 3 is a flow chart of a method for power processing according to the first embodiment of the present document;

FIG. 4 is a flow chart of a method for power processing according to the second embodiment of the present document;

FIG. 5 is a flow chart of a method for power processing according to the third embodiment of the present document;

FIG. 6 is a schematic diagram of a terminal according to the embodiment of the present document.

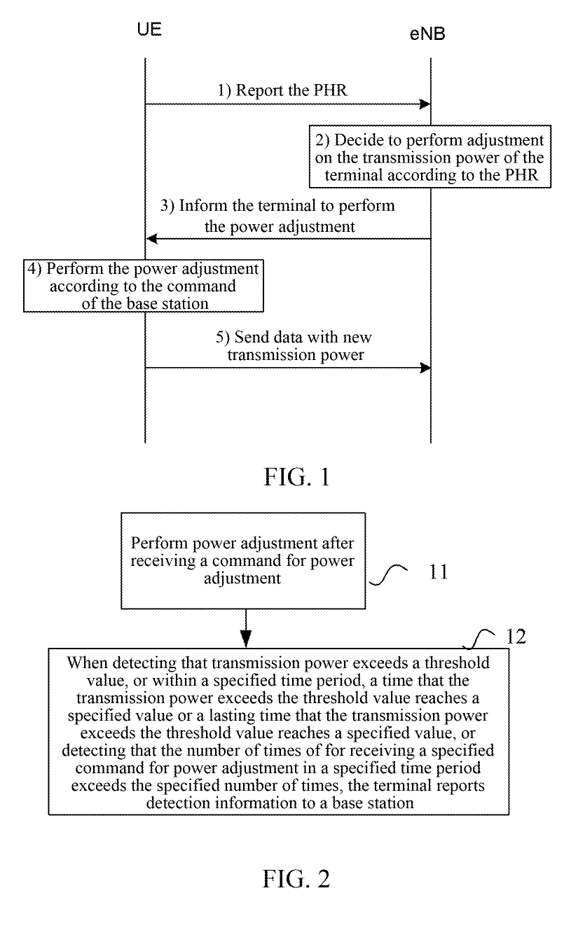

### PREFERRED EMBODIMENTS

Under the background of Dual Connectivity, PHR reporting and power control process still may perform according to the cells, the MeNB and SeNB need know the PHR of two cells at the same time, then power control can be performed well. At the same time, when the power allocation of the cells at the MeNB and SeNB needs to be negotiated, as the time delay between the multiple network nodes cannot be ignored, the negotiation in the control process can cause the delay of power control, and the power control becomes not in time, thereby the probability that the current transmission power of the terminal exceeds a maximum transmission power of the UE will increase, or the number of times of the power adjustment for the terminal will be more.

FIG. 2 is a flow chart of a method for power processing according to the embodiment of the present document, as shown in FIG. 2, the method of the present embodiment comprises:

in step 11, after receiving a command for power adjustment, a terminal performs power adjustment;

in step 12, when detecting that transmission power exceeds a threshold value, or within a specified time period, a time that the transmission power exceeds the threshold value reaches a specified value or a lasting time that the transmission power exceeds the threshold value reaches a specified value, or detecting that the number of times for receiving a specified command for power adjustment in a specified time period exceeds the specified number of times, the terminal reports detection information to a base station.

In the present embodiment, after the terminal performs the power adjustment, the transmission power exceeds the specified power threshold, for example, the maximum transmission power of the terminal, the terminal reports to the base station.

Or, the terminal frequently receives a command for performing the power adjustment in a specified time, for example, after exceeding the specified number of times, the terminal informs the base station, the base station performs a further power coordination or reduces the number of times of power adjustment after receiving the information. The power adjustment may include only power increase, or include only power reduction, or both. The base station to which information is reported may be MeNB, or SeNB, or both.

The command reported to the base station may include, the number of times of power increase adjustment, the number of times of power reduction adjustment, the number of times of power adjustment (including power increase and power reduction).

With the method provided by the embodiment of the present document, the probability that the current transmission power of the terminal exceeds a maximum transmission power can be reduced, and the number of times of the power adjustment for the terminal can be reduced.

The embodiments of the present document will be described in detail in combination with the accompanying drawings below. It should be noted that the embodiments and the characteristics of the embodiments in the present application can be arbitrarily combined with each other in the case of no conflict.

In the following embodiments, the base station 1 is a macro base station, there is one cell, cell 1, the base station 2 is a small cell base station, there are two cells, cell 3 and cell 4 respectively.

### Embodiment 1

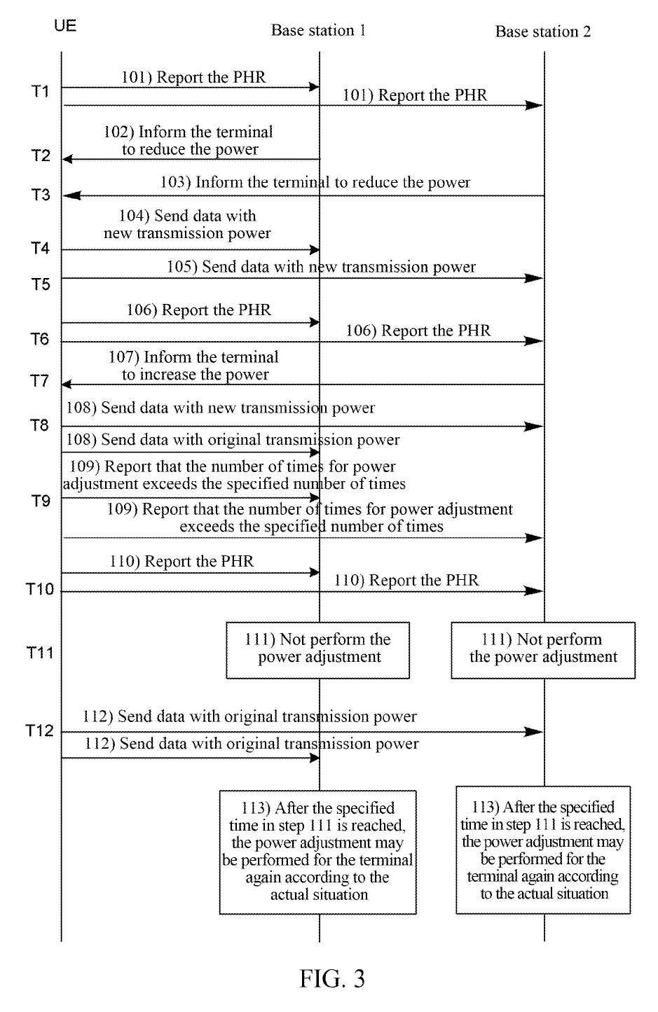

The terminal sets up a connection with the cell 1, as the amount of service increases, the base station 1 adds the cell 3 for the terminal according to the measurement report, the base station 1 informs the terminal, in a specified time period, for example, within 5 seconds, if the number of times of the power adjustment exceeds three times (including three times), then the terminal will report, as shown in FIG. 3, the following steps are comprised:

In step 101, at time T1, the terminal reports the PHR of all the servicing cells to corresponding base stations, that is, the terminal reports the PHR of the cell 1 and the cell 3 to the base station 1, at the same time, the terminal reports the PHR of the cell 1 and the cell 3 to the base station 2.

In step 102, at time T2, the base station 1 receives the PHR, decides to perform the power control for the terminal, and informs the terminal that the transmission power needs to be reduced.

In step 103, at time T3, the base station 2 receives the PHR, decides to perform the power control for the terminal, and informs the terminal that the transmission power needs to be reduced.

In step 104, at time T4, the terminal receives a command for performing the power adjustment from the base station 1, performs the power adjustment, and sends data with the adjusted power.

In step 105, at time T5, the terminal receives a command for performing the power adjustment from the base station 2, performs the power adjustment, and sends data with the adjusted power.

In step 106, at time T6, the terminal reports the PHR of the cell 1 and the cell 3 to the base station 1, at the same time, the terminal reports the PHR of the cell 1 and the cell 3 to the base station 2.

In step 107, at time T7, the base station 2 receives the PHR, decides to perform the power control for the terminal, and informs the terminal that the transmission power needs to be reduced;

the base station 1 decides that the power adjustment do not need to be performed, thereby the base station 1 does not send a command for power adjustment to the terminal.

In step 108, at time T8, the terminal receives a command for performing the power adjustment from the base station 2, performs the power adjustment, and sends data with the adjusted power.

The terminal does not receive a command for power adjustment, and continues sending data with original power.

In step 109, the terminal detects that, it does not exceed 5 seconds from time T2 to time T8, but the terminal has already received the command for power adjustment 3 times, thereby, the terminal needs to inform the base station, and reports to the base station 1 and the base station 2 that the number of times of the power adjustment exceeds the specified number of times.

Or, the terminal reports the following information to the base station 1 and the base station 2: the number of times for receiving the power reduction is 2, the number of times for receiving the power increase is 1.

Or, the terminal reports the following information to the base station 1 and the base station 2: the number of times for receiving the power reduction sent by the base station 1 is 1, the number of times for receiving the power increase sent by the base station 1 is 0, the number of times for receiving the power reduction sent by the base station 2 is 1, the number of times for receiving the power increase sent by the base station 2 is 1.

In step 110, at time T10, the terminal reports the PHR of the cell 1 and the cell 3 to the base station 1, at the same time, the terminal reports the PHR of the cell 1 and the cell 3 to the base station 2.

In step 111, at time T11, the base station 2 receives the PHR, at first, the power control needs to be performed by the terminal to increase the transmission power, since the terminal reports the power adjustment quite frequently, and it does not exceed the specified time (may be pre-configured, or specified by the protocol), thereby, the base station 2 decides not to perform the power control.

The base station 1 decides that the power adjustment does not need to be performed, thereby the base station 1 does not send the command for power adjustment to the terminal.

In step 112, at time T12, the terminal does not receive the command for power adjustment sent by the base station 2 and the base station 1, and continues performing the data transmission with original power.

In step 113, after the specified time in step 111 is reached, the base station 1 and the base station 2 may perform the power adjustment for the terminal again according to the actual situation.

In the above step 109, after the base station learned that the terminal performs the power adjustment quite frequently, the power negotiation between the base stations may be performed.

### Embodiment 2

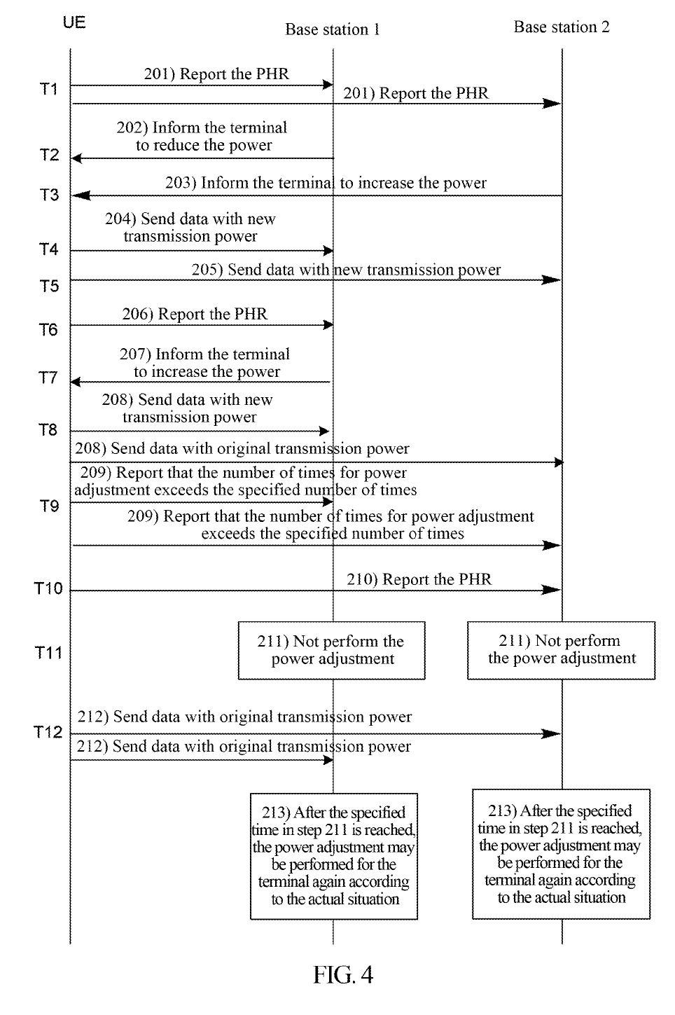

The terminal sets up a connection with the cell 1, as the amount of service increases, the base station 1 adds the cell 3 for the terminal according to the measurement report, the base station 1 informs the terminal, in a specified time period, for example, within 5 seconds, if the number of times for performing the same power adjustment exceeds twice (including twice), then the terminal will report. At this moment, the same power adjustment refers to needing to reduce the power, or needing to increase the power, as shown in FIG. 4, the following steps are comprised:

In step 201, at time T1, the terminal only reports the PHR of the cells related to the base stations to the corresponding base stations, that is, the terminal reports the PHR of the cell 1 to the base station 1, at the same time, the terminal reports the PHR of the cell 3 to the base station 2.

In step 202, at time T2, the base station 1 receives the PHR, decides to perform the power control for the terminal, and informs the terminal that the transmission power needs to be reduced.

In step 203, at time T3, the base station 2 receives the PHR, decides to perform the power control for the terminal, and informs the terminal that the transmission power needs to be reduced.

In step 204, at time T4, the terminal receives a command for performing the power adjustment from the base station 1, performs the power adjustment, and sends data with the adjusted power.

In step 205, at time T5, the terminal receives a command for performing the power adjustment from the base station 2, performs the power adjustment, and sends data with the adjusted power.

In step 206, at time T6, the terminal reports the PHR of the cell 1 to the base station 1.

In step 207, at time T7, the base station 1 receives the PHR, decides to perform the power control for the terminal, and informs the terminal that the transmission power needs to be increased.

In step 208, at time T8, the terminal receives the command for performing the power adjustment from the base station 1, performs the power adjustment, and sends data with the adjusted power;

the terminal does not receive the command for power adjustment sent by the base station 2, continues sending data with original power.

In Step 209, the terminal detects that, it does not exceed 5 seconds from time T2 to time T8, but the terminal has already received the command for power increase adjustment twice, thereby, the terminal needs to inform the base station, and reports to the base station 1 and the base station 2 that the number of times of the power adjustment exceeds the specified number of times. Or the terminal only reports to the base station 1 or the base station 2.

In step 210, at time T10, the terminal reports the PHR of the cell 3 to the base station 2.

In step 211, at time T11, the base station 2 receives the PHR, at first, the power control needs to be performed by the terminal to increase the transmission power, since the terminal reports the power adjustment quite frequently, and it does not exceed the specified time (may be pre-configured, or specified by the protocol), thereby, the base station 2 decides not to perform the power control.

In step 212, at time T12, the terminal does not receive the command for power adjustment sent by the base station 2 and the base station 1, continues performing the data transmission with original power;

In step 213, after the specified time in step 211 is reached, the base station 1 and the base station 2 may perform the power adjustment for the terminal again according to the actual situation.

### Embodiment 3

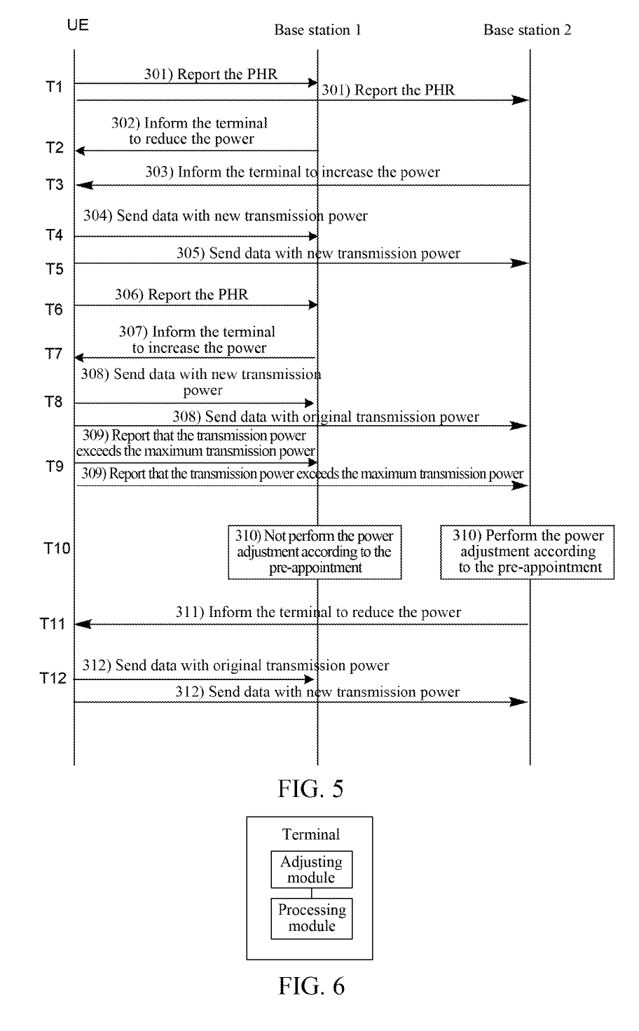

The terminal sets up a connection with the cell 1, as the amount of service increases, the base station 1 adds the cell 3 for the terminal according to the measurement report, the base station 1 informs the terminal, that in a specified time period, for example, within 50 milliseconds, the time that the transmission power of the terminal exceeds a specified power threshold, for example, the maximum transmission power, exceeds 10 ms, then the terminal reports to the base station, as shown in FIG. 5, the following steps are comprised:

In step 301, at time T1, the terminal only reports the PHR of the cells related to the base stations to the corresponding base stations, that is, the terminal reports the PHR of the cell 1 to the base station 1, at the same time, the terminal reports the PHR of the cell 3 to the base station 2.

In step 302, at time T2, the base station 1 receives the PHR, decides to perform the power control for the terminal, and informs the terminal that the transmission power needs to be increased.

In step 303, at time T3, the base station 2 receives the PHR, decides to perform the power control for the terminal, and informs the terminal that the transmission power needs to be increased.

In step 304, at time T4, the terminal receives the command for performing the power adjustment from the base station 1, performs the power adjustment, and sends data with the adjusted power.

In step 305, at time T5, the terminal receives the command for performing the power adjustment from the base station 2, performs the power adjustment, and sends data with the adjusted power.

In step 306, at time T6, the terminal reports the PHR of the cell 1 to the base station 1.

In step 307, at time T7, the base station 1 receives the PHR, decides to perform the power control for the terminal, and informs the terminal that the transmission power needs to be increased.

In step 308, at time T8, the terminal receives the command for performing the power adjustment from the base station 1, performs the power adjustment, and sends data with the adjusted power;

the terminal does not receive the command for power adjustment sent by the base station 2, and continues sending data with original power.

In Step 309, the terminal detects that, at time T8, within 50 milliseconds, the transmission power of the terminal has exceeded the maximum transmission power for 10 milliseconds, the terminal reports to the base station 1 and the base station 2.

In Step 310, the base station 1 and the base station 2 receive the reports of the terminal, according to pre-appointment, the base station 2 performs the power adjustment on the terminal, or performs a power allocation negotiation again;

In step 311, at time T11, the base station 2 informs the terminal that the transmission power needs to be reduced.

In step 312, at time T12, the terminal receives a command for performing the power adjustment from the base station 2, performs the power adjustment, and sends data with the adjusted power;

the terminal does not receive the command for power adjustment sent by the base station 1, continues performing the data transmission with original power. In the above embodiment, in step 311, it may be the base station 1 informing the terminal. A certain TTI (transmission time interval), the terminal performs the power adjustment that exceeds a specified threshold, such as 10 dB, then reports to the base station, if the base station 1 needs the terminal to increase the power with 6 dB, the base station 2 needs the terminal to increase the power with 8 dB, the two items adding together exceeds 10 dB, so the threshold is exceeded, then the terminal reports to the base station.

The number of servicing cells configured by the terminal may include one, two, three, etc., the process is the same, and will not to be repeated. That is, in the above embodiments, the terminal is configured by cell 1, cell 3 and cell 4, the terminal may report the PHR of the cell 1 to the base station 1, or report the PHR of the cell 3 and cell 4 to the base station 2, or report the PHR of the cell 1, cell 3 and cell 4 to the base station 1 and the base station 2.

FIG. 6 is a schematic diagram of the terminal of the embodiment of the present document, as shown in FIG. 6, the terminal of the present embodiment comprises:

an adjusting module, configured to: after receiving a command for power adjustment, perform power adjustment;

a processing module, configured to: when detecting that transmission power exceeds a threshold value or within a specified time period, a time that the transmission power exceeds the threshold value reaches a specified value or a lasting time that the transmission power exceeds the threshold value reaches a specified value, or detecting that the number of times for receiving a specified command for power adjustment in a specified time period exceeds the specified number of times, report detection information to a base station.

Wherein, the number of times for receiving the specified command for power adjustment which is detected by the processing module comprises the number of times for receiving the following commands: a command for power increase, or a command for power reduction, or a command for power increase and a command for power reduction.

Wherein, the threshold value which is exceeded by the transmission power detected by the processing module comprises a maximum transmission power of the terminal.

Wherein, the processing module reporting detection information to the base station comprises: reporting the detection information to a macro base station; reporting the detection information to a small cell base station; or reporting the detection information to a macro base station and a small cell base station.

Obviously, the ordinary person skilled in the art can understand that, each module or each step in the present document above-mentioned can be implemented in a commonly used computing device, they can be centralized on a single computing device, or distributed on the network composed by a plurality of computing devices, alternatively, they can be implemented with the computing device executable program code, thus, they can be stored in a storage device and be performed by the computing device, and in some cases, the steps as shown or described can be performed by the order that different from here, or they are respectively made into various integrated circuit module, or a plurality of modules or steps of them are made into a single integrated circuit module to be implemented. In this way, the present document is not limited to any specific combination of hardware and software.

The above description is only the preferred embodiments of the present document, which is not used to limit the present document, for the one skilled in the art, the present document can make various modifications and changes. All the modifications, equivalent substitutions, and improvements, etc. made within the essence and principle of the present document shall fall into the protection scope of the present document.

### INDUSTRIAL APPLICABILITY

The embodiment of the present document provides a method for power processing and a terminal, which can reduce the probability that the current transmission power of the terminal exceeds a maximum transmission power, or reduce the number of times of the power adjustment for the terminal.

What is claimed is:

1. A method for power processing, comprising:
after receiving a command for power adjustment, a terminal performing power adjustment;
when detecting that transmission power exceeds a threshold value, or within a specified time period, a time that the transmission power exceeds the threshold value reaches a specified value or a lasting time that the transmission power exceeds the threshold value reaches a specified value, or detecting that a number of times for receiving a specified command for power adjustment in a specified time period exceeds a specified number of times, the terminal reporting detection information to a base station.

2. The method according to claim 1, wherein,
the threshold value comprises maximum transmission power of the terminal.

3. The method according to claim 1, wherein, the number of times for receiving a specified command for power adjustment comprises a number of times for receiving the following commands:
a command for power increase, or
a command for power reduction, or
a command for power increase and a command for power reduction.

4. The method according to claim 1, wherein, said reporting detection information to a base station comprises:
reporting the detection information to a macro base station; or
reporting the detection information to a small cell base station; or
reporting the detection information to a macro base station and a small cell base station.

5. A terminal, comprising:
an adjusting module, configured to, after receiving a command for power adjustment, perform power adjustment;
a processing module, configured to, when detecting that transmission power exceeds a threshold value, or within a specified time period, a time that the transmission power exceeds the threshold value reaches a specified value or a lasting time that the transmission power exceeds the threshold value reaches a specified value, or detecting that a number of times for receiving a specified command for power adjustment in a specified time period exceeds a specified number of times, report detection information to a base station.

6. The terminal according to claim 5, wherein:
the threshold value which is exceeded by the transmission power detected by the processing module, comprises maximum transmission power of the terminal.

7. The terminal according to claim 5, wherein:
the number of times for receiving a specified command for power adjustment which is detected by the processing module comprises a number of times for receiving the following commands: a command for power increase, or a command for power reduction, or a command for power increase and a command for power reduction.

8. The terminal according to claim 5, wherein:
the processing module being configured to report detection information to the base station comprises: reporting the detection information to a macro base station; reporting the detection information to a small cell base station; or reporting the detection information to a macro base station and a small cell base station.

9. The method according to claim 2, wherein, said reporting detection information to a base station comprises:
reporting the detection information to a macro base station; or
reporting the detection information to a small cell base station; or
reporting the detection information to a macro base station and a small cell base station.

10. The method according to claim 3, wherein, said reporting detection information to a base station comprises:
reporting the detection information to a macro base station; or
reporting the detection information to a small cell base station; or
reporting the detection information to a macro base station and a small cell base station.

11. The terminal according to claim 6, wherein:
the processing module being configured to report detection information to the base station comprises: reporting the detection information to a macro base station; reporting the detection information to a small cell base station; or reporting the detection information to a macro base station and a small cell base station.

12. The terminal according to claim 7, wherein:
the processing module being configured to report detection information to the base station comprises: reporting the detection information to a macro base station; reporting the detection information to a small cell base station; or reporting the detection information to a macro base station and a small cell base station.
